(19) United States
(12) Patent Application Publication
(10) Pub. No.: US 2009/0244742 A1
(43) Pub. Date: Oct. 1, 2009

(54) MIRROR DEVICE FOR SUN VISOR OF VEHICLE

(75) Inventor: Hyo Keun Kim, Suwon-si (KR)

Correspondence Address: MORGAN, LEWIS & BOCKIUS LLP (SF), One Market, Spear Street Tower, Suite 2800, San Francisco, CA, 94105, US

(73) Assignee: Hyundai Motor Company, Seoul (KR)

(21) Appl. No.: 12/177,672

(22) Filed: Jul. 22, 2008

(30) Foreign Application Priority Data
Mar. 26, 2008 (KR) 10-2008-0027711

(51) Int. Cl. G02B 7/198; B60J 3/00

(52) U.S. Cl. 359/844; 359/881; 359/838

(57) ABSTRACT

The present invention relates to a mirror device for a sun visor of a vehicle, in which when a cover of a mirror mounted to a sun visor is opened or closed, the mirror can be operated smoothly and completely, comprising: a mirror housing having a mirror and a cover sliding from the mirror housing to open or close the mirror, wherein the mirror housing and the cover are coupled to each other by an elongation member. Accordingly, the cover moves smoothly in a semi-automatic sliding manner by means of an elastic body, thereby restraining noise from being generated.

### CROSS-REFERENCE TO RELATED APPLICATION

This application claims priority to and the benefit of Korean Patent Application No. 10-2008-0027711, filed in the Korean Intellectual Property Office on Mar. 26, 2008, the entire contents of which are incorporated herein by reference.

### BACKGROUND OF THE INVENTION

1. Field of the Invention

The present invention relates to a mirror device for a sun visor of a vehicle, and more particularly, to a mirror device for a sun visor of a vehicle, in which a cover of a mirror mounted to a sun visor can be opened or closed smoothly and completely.

2. Description of Related Art

Generally, a sun visor of a vehicle is a panel provided on a bottom of a roof panel of a driver seat or a passenger seat to prevent a ray of light from being thrown directly on a driver or a passenger so that driver's or passenger's front view is ensured.

Usually, the sun visor may be lowered forward to block a direct ray of light input through a wind shield glass, and may be turned aside also to block a direct ray of light input through a side window glass.

A mirror, which is one of convenient tools for a passenger, is attached to one surface of the sun visor. A cover capable of being opened or closed is installed to a rear side of the mirror and is configured to be closed when the mirror is not in use so as to prevent impurities from adhering to the mirror or other objects from being not reflected thereon.

The conventional mirror device for a sun visor of a vehicle includes a sun visor provided inside of a vehicle, a mirror housing including a mirror attached to the sun visor, and a cover positioned to a rear side of the mirror inside the mirror housing and capable of sliding along lateral sides of the mirror housing.

Here, if the cover slides in a linear direction along the lateral sides of the mirror housing, the mirror is accordingly opened or closed, so that a driver or passenger may use the mirror inside of the vehicle.

Meanwhile, a switch is provided at one side of the sun visor, so that when the mirror of the sun visor is used, a vanity lamp that is a separated lighting device is turned on in accordance with the sliding and opening of the cover.

However, since a driver or a passenger in the conventional mirror device for a sun visor of a vehicle slides manually the cover of the mirror attached to the sun visor inside of the vehicle, if the user does not completely open or close the cover, the switch is not securely operated and thus causes a misoperation of the vanity lamp. Also noise is generated while the vehicle is running since the cover is not completely secured, thereby deteriorating the product quality.

The information disclosed in this Background of the Invention section is only for enhancement of understanding of the background of the invention and should not be taken as an acknowledgement or any form of suggestion that this information forms the prior art that is already known to a person skilled in the art.

### SUMMARY OF THE INVENTION

The present invention is conceived to solve the aforementioned problems in the prior art. An object of the present invention is to provide a mirror device for a sun visor of a vehicle, and more particularly, a mirror device for a sun visor of a vehicle, in which when a cover of a mirror mounted to a sun visor is opened or closed, the mirror can be operated smoothly and completely.

An exemplary embodiment according to the present invention comprises a mirror housing having a mirror and a cover sliding from the mirror housing to open or close the mirror, wherein the mirror housing and the cover are coupled to each other by an elongation member that is elastically deformable.

The elongation member may comprise: a case; and a guide groove formed through the case; a pivot arm guided in the guide groove; and an elastic body coupling the case and a distal end of the pivot arm.

The case of the elongation member may be coupled to the mirror housing and the pivot arm is coupled to the cover.

A coupling point of the case of the elongation member and the mirror housing may not be positioned at the same level as a coupling point of the pivot arm and the cover.

Further, the elastic body may be a spring.

As another exemplary embodiment of the present invention, the case of the elongation member may be coupled to the cover and the pivot arm is coupled to the mirror housing.

A coupling point of the case of the elongation member and the cover may not be positioned at the same level as a coupling point of the pivot arm and the mirror housing.

As further exemplary embodiment of the present invention, the elongation member may comprise: a case; a guide groove formed through the case; two separate pivot arms guided in the guide groove; and an elastic body coupling the two separate pivot arms inside the case, wherein the two pivot arms are respectively coupled to the mirror housing and the cover.

The case may further comprise at least a catching portion formed at opening of the guide groove and the pivot arms further comprises at least a protrusion formed at an inner end of the pivot arm in the case to prevent the pivot arms from separating from the case.

Each end of the elongation member may be coupled to the mirror housing and the cover respectively.

A coupling point of the elongation member and the mirror housing may not be positioned at the same level as a coupling point of the elongation member and the cover.

As an further another exemplary embodiment of the present invention, a mirror device for a sun visor of a vehicle, which is provided on a sun visor of a vehicle, may comprise a mirror housing having a mirror and a cover sliding from the mirror housing to open or close the mirror, wherein the mirror housing and the cover are respectively coupled to both ends of a torsion sprig.

A coupling point of the torsion spring and the mirror housing may not be positioned at the same level as a coupling point of the torsion spring and the cover.

The torsion spring may comprise a plurality of torsion springs.

According to the present invention as described above, the cover moves smoothly in a semi-automatic sliding manner by means of an elastic body, thereby restraining noise from being generated. At the same time, the cover is completely opened and closed and can be prevented from being misoperated, thereby enhancing user's convenience and improving the product quality of a vehicle.

### BRIEF DESCRIPTION ON THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 shows a close or open state of a mirror according to operation of a cover for a sun visor of a vehicle in an exemplary embodiment of the present invention;

FIG. 2 shows a partial view of the sun visor including a mirror device as illustrated in FIG. 1 in an exemplary embodiment of the present invention;

FIG. 3 shows a top plane view in close state of a mirror device in line A-A of FIG. 2 for a sun visor according to an exemplary embodiment of the present invention;

FIG. 4 shows a top plane view in open state of the mirror device for a sun visor according to an exemplary embodiment of the present invention;

FIG. 5 shows an example of an elongation member of the mirror device for a sun visor of a vehicle in an exemplary embodiment of the present invention;

FIG. 6 shows another example of the elongation member for a sun visor of a vehicle in an exemplary embodiment of the present invention;

FIG. 7 shows another example of the elongation member showing a open and close state of a mirror device for a sun visor of a vehicle in another exemplary embodiment of the present invention; and

FIG. 8 shows further another example of the elongation member showing a close state of a mirror device for a sun visor of a vehicle in another exemplary embodiment of the present invention.

In the figures, reference numbers refer to the same or equivalent parts of the present invention throughout the several figures of the drawing.

[Representative Reference Numerals]

| | |
|---|---|
| 10: Sun visor | 20: Mirror housing |
| 21: Mirror | 30: Cover |
| 100: Elongation member | 110, 110': Case |
| 111, 111': Guide groove | 112, 121, 121a, 121b: Coupling hole |
| 113: Catching portion | 120, 120a, 120b: Pivot arm |
| 122a, 122b: Protrusion | 130: Elastic body |
| 200: Torsion spring | 210: Connecting portion |

### DETAILED DESCRIPTION OF THE INVENTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

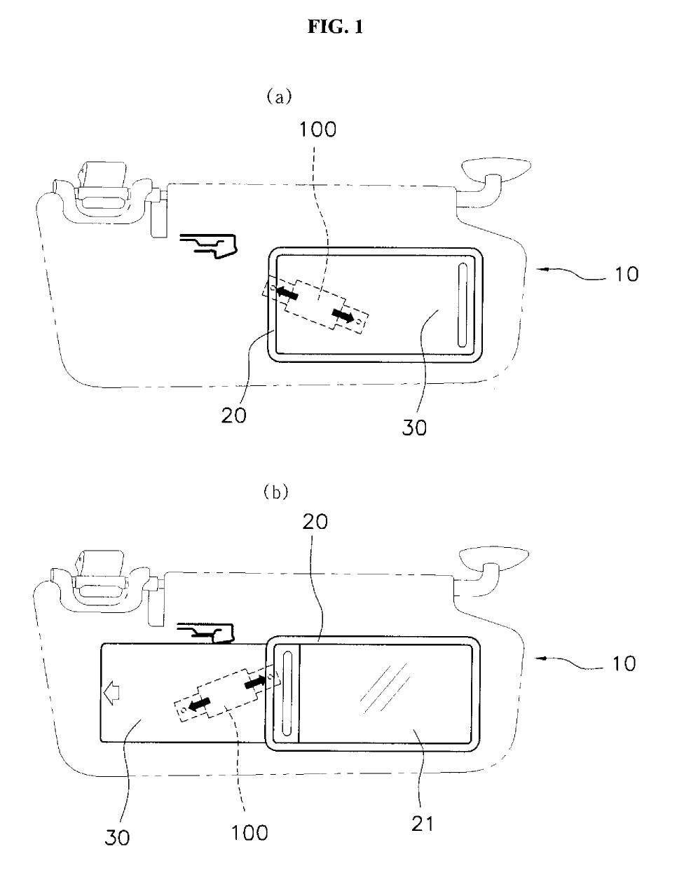

FIG. 1 shows a close or open state of a mirror according to operation of a cover for a sun visor of a vehicle in an exemplary embodiment of the present invention. In particular, FIG. 1(a) shows that a cover is in a close state, and FIG. 1(b) shows that the cover is in an open state.

The mirror device 5 for a sun visor of a vehicle according to the present invention is provided at a sun visor 10 of a vehicle.

The mirror device 5 includes: a mirror 21, a cover 30 positioned at rear side of the mirror 21, an elongation member 100 positioned between the mirror 20 and the cover 30, and a mirror housing 20 receiving the mirror 21 and the cover 30 therein wherein the cover 30 moves slidably from or to the mirror housing 20 in order to open or close the mirror 21.

In the an exemplary embodiment of the present invention, each end of the elongation member 100 placed between the mirror 21 and the cover 30 is pivotally coupled to the mirror housing 20 and the cover 30 respectively as explained later.

The elongation member 100 may comprise members that can be elastically deformable or a torsion spring and thus the cover 30 can move smoothly in a semi-automatic sliding manner by means of an elastic body of the cover 30. Due to the elongation member 100, the cover 30 can be completely opened or closed such that noise is more restrained than conventional art and the switch 80 is securely operated compared to conventional art.

The elongation member 100 will be explained hereinafter in detail.

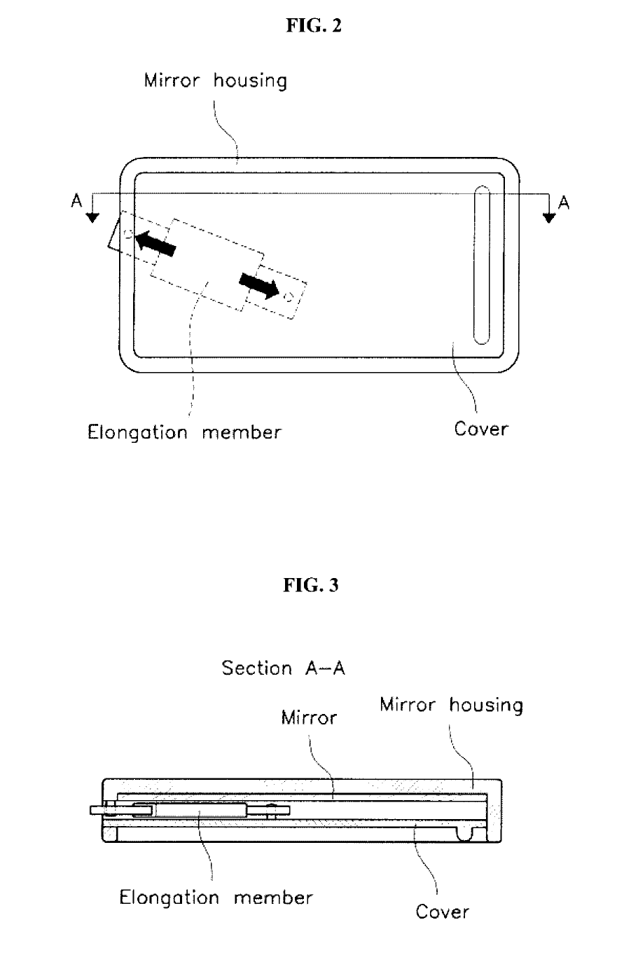

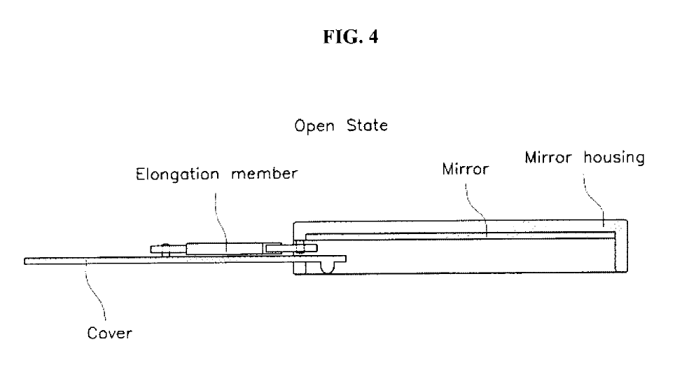

FIG. 2 shows a partial view of the sun visor including the mirror device 5 as illustrated in FIG. 1 in an exemplary embodiment of the present invention, FIG. 3 shows a top plane view in close state of the mirror device 5 in line A-A of FIG.2 for a sun visor according to an exemplary embodiment of the present invention, and FIG. 4 shows a top plane view in open state of the mirror device 5 for a sun visor according to an exemplary embodiment of the present invention.

As shown in FIGS. 3 and 4, the elongation member 100 is positioned between the mirror 21 and the cover 30 in a mirror housing 20. The cover 30 is positioned at rear side of the mirror 21. In an exemplary embodiment, the mirror housing 20 includes an opening 25 positioned left in drawing through which the cover 30 moves slidably.

The cover 30 includes a protrusion 60 formed at rear surface of the cover 30 and thus prevents the cover 30 from separating from the mirror housing 20.

The elongation member 100 includes an elastic body which is elastically deformative and elongative. One end of the elongation member 100 is pivotally coupled to inner surface of the opening 25 via a pin 40 and other end of the elongation member 100 is pivotally coupled to inner surface of cover 30 via a pin 50. The elongation member 100 can be elastically deformed.

In particular, the elongation member 100 is connected to the mirror housing 20 and the cover 30 with a predetermined slope with respect to a longitudinal direction of the mirror device. Thus, when the cover 30 is in a close state as shown in FIG. 1(a), the cover 30 maintains a close state more fully by the elastically restoring force of the elongation member 100. Also, when the cover 30 is in an open state as shown in FIG. 1(b), the cover 30 may maintain its open state more fully by the elastically restoring force of the elongation member 100.

Hereinafter, various embodiments of the elongation member 100 of the present invention will be described in detail with reference to the accompanying drawings.

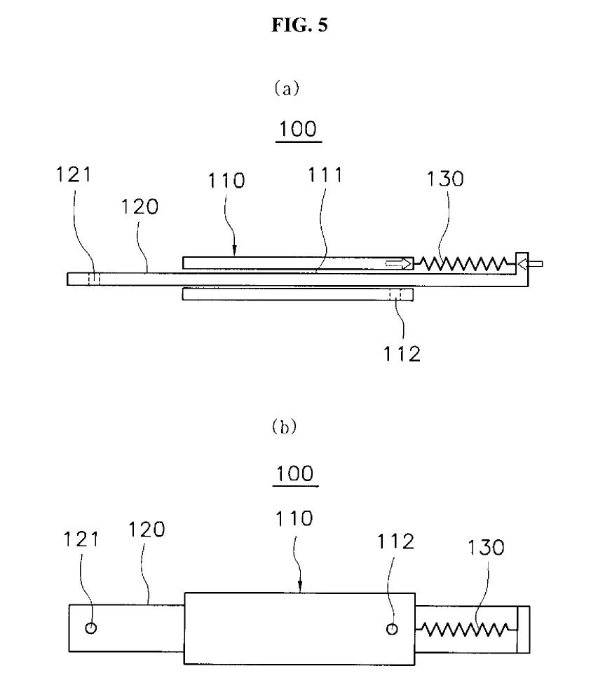

First, the elongation member 100 according to a preferred example of the present invention includes a case 110 having a guide groove 111 formed therein and coupled to the mirror housing 20 via coupling hole 112; a pivot arm 120 coupled to the cover 30 via a coupling hole 121 and guided through the guide groove 111 of the case 110; and an elastic body 130 connecting the case 110 and other end of the pivot arm 120, as shown in FIG. 5.

The guide groove 111 of the case 110 is a slot formed through the case 110 so as to guide the pivot arm 120 in a longitudinal direction of the elongation member 100. Since the coupling hole 112 is formed in one side of the case 110, the case 110 is rotatable about the mirror housing 20.

Also, the pivot arm 120 is formed in the shape of a panel. Since the coupling hole 121 is formed in one side of the pivot arm 120 opposite to the coupling hole 112 formed on the case 110, the pivot arm 120 is rotatable about the cover 30. Also, the other side of pivot arm 120 is positioned through the guide groove 111 of the case 110.

A distal end of the pivot arm 120 wherein the elastic body 130 is positioned may be bent to prevent the pivot arm 120 from being separated through the guide groove 111. The elastic body 130, such as a coil spring, which may be elastically contracted or restored, is connected to the case 110 and the distal end of the pivot arm 120.

According to this configuration, in a state where the cover 30 is closed as shown in FIG. 1(a), if the cover 30 is slid and moved in a left direction in the figure as shown in FIG. 1(b) in order to use the mirror 21, the pivot arm 120 coupled to the cover 30 by pin 50 is rotated about the coupling hole 121, and at the same time, the case 110 coupled to the mirror housing 20 by a pin 40 is rotated together about the coupling hole 112.

Accordingly, the elastic body 130 is elastically tensed up to a point where the pivot arm 120 and the case 110 are positioned vertically in the figure, and as the user opens the cover 30 further, the tensed elastic body 130 is elastically restored, thereby causing the cover 30 to be opened in a semi-automatic manner.

Of course, the operation is made in the same manner when closing the opened cover 30.

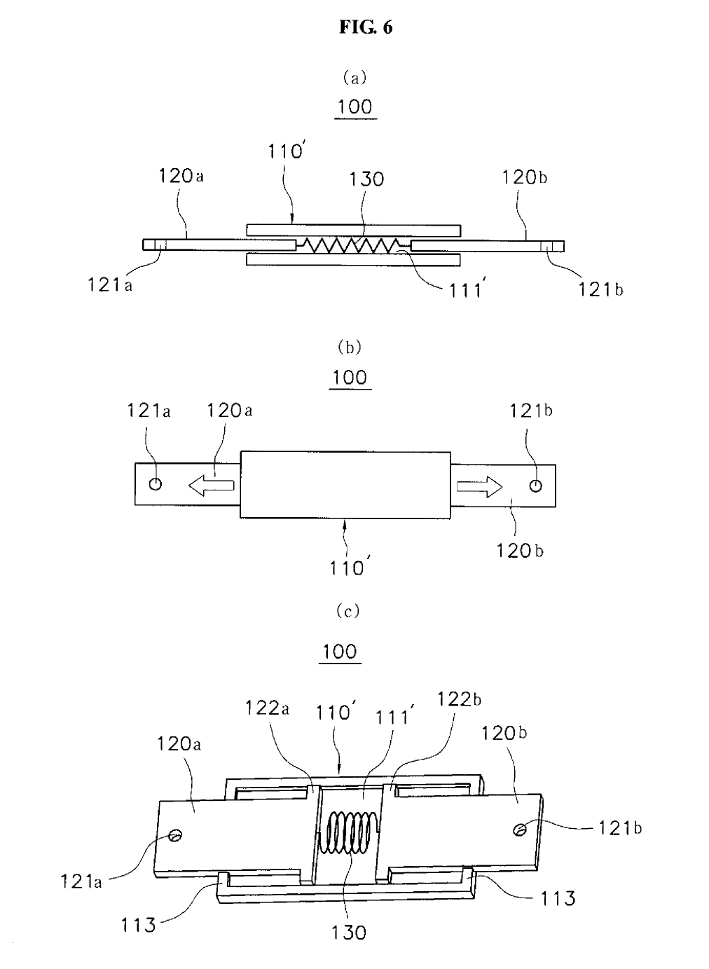

Secondly, another preferred example of the elongation member 100 according to the present invention includes a case 110′ having a guide groove 111′ formed therethrough, two pivot arms 120a and 120b respectively connected to the cover 30 and the mirror housing 20 to be guided in the guide groove 111′, and an elastic body 130 coupling the two pivot arms 120a and 120b inside the case 110′, as shown in FIG. 6(a) and 6(c).

The guide groove 111′ is a slot formed through the case 110′ so as to guide the two pivot arms 120a and 120b positioned at both sides in a longitudinal direction of the elongation member 100 in the figure. Also, the case 110′ has catching portions 113 formed in correspondence to protrusions 122a and 122b of the pivot arms 120a and 120b, which will be described later.

In addition, the two pivot arms 120a and 120b have panel shapes that are bilaterally symmetric. Also, a coupling hole 121a is formed in the pivot arm 120a positioned in the left side in the figure, so that the pivot arm 120a is rotatably coupled to the cover 30 through the coupling hole 121a by pin 50. In addition, the other side of the pivot arm 120a is positioned in the guide groove 111′ of the case 110′ and is formed with a protrusion 122a so as to prevent the pivot arm 120a from being separated from the guide groove 111′.

A coupling hole 121b is also formed in the pivot arm 120b positioned in the right side in the figure, so that the pivot arm 120b is rotatably coupled to an inner portion of the opening 25 of the mirror housing 20 through the coupling hole 121b by pin 40. The other side of the pivot arm 120b is positioned in the guide groove 111′ of the case 110′ and is formed with a protrusion 122b so as to prevent the pivot arm 120b from being separated from the guide groove 111′.

Also, the elastic body 130 such as a coil spring that is elastically deformable is coupled to the two pivot arms 120a and 120b in the guide groove 111′.

According to the configuration, if the cover 30 is slid and moved in the left direction in the figure as shown in FIG. 1(b) in order to use the mirror 21 in a state where the cover 30 is in a close state as shown in FIG. 1(a), the pivot arm 120a coupled to the cover 30 is rotated about the coupling hole 121a, and at the same time, the pivot arm 120b coupled to the mirror housing 20 is rotated together about the coupling hole 121b.

Accordingly, the elastic body 130 is elastically contracted up to a point where the pivot arms 120a and 120b are positioned vertically in the figure, and then, the contracted elastic body 130 is elastically restored by its elastic restoring force, thereby causing the cover 30 to be opened in a semi-automatic manner.

Of course, the operation is made in the same manner when closing the opened cover 30.

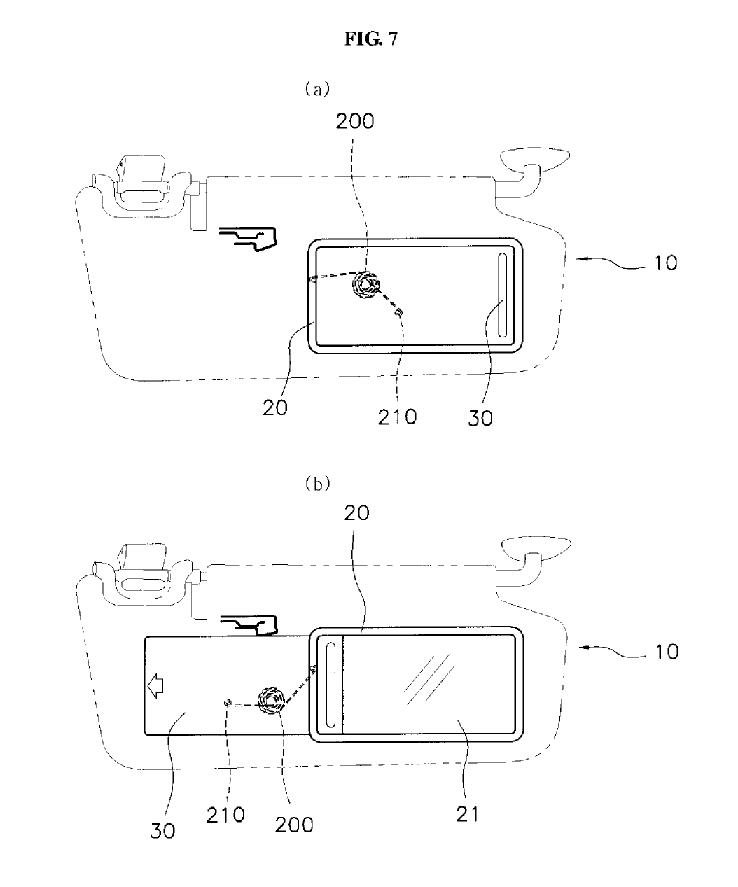

In the another exemplary embodiment of the present invention, as shown in FIG. 7, the sun visor 10 of a vehicle includes the mirror housing 20 with the mirror 21 and the cover 30, wherein the mirror housing 20 and the cover 30 are coupled to both ends of the torsion spring 200 positioned between the mirror 21 and the cover 30.

The torsion spring 200 is a coil spring wherein a connection portion 205 of the torsion spring 200 is coupled to the mirror housing 20, and a connection portion 210 thereof is coupled to the cover 30. Both ends of the torsion spring 200 are respectively connected to the mirror housing 20 and the cover 30 with a predetermined slope with respect to a longitudinal direction of the mirror device by pins 40 and 50.

According to this configuration, in a state where the cover 30 is closed as shown in FIG. 7(a), if the cover 30 is slid and moved in the left direction in the figure as shown in FIG. 4(b), the torsion spring 200 coupled to the cover 30 and the mirror housing 20 is rotated together.

Accordingly, the torsion spring 200 is elastically contracted up to a point where a connecting portion 205 of the torsion spring 200 coupled to the mirror housing 20 and a connecting portion 210 of the torsion spring 200 coupled to the cover 30 are positioned vertically in the figure, and as a user opens the cover 30 further, the contracted torsion spring 200 is elastically restored by its elastic restoring force, thereby causing the cover 30 to be opened in a semi-automatic manner.

Of course, the operation is made in the same manner when closing the opened cover 30.

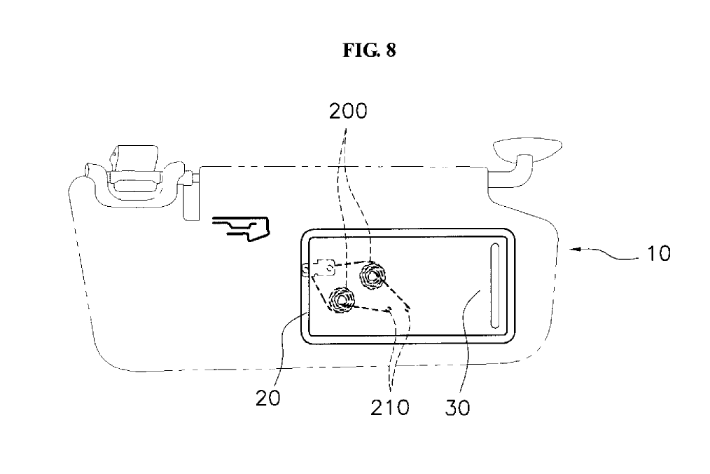

In a further exemplary embodiment of the present invention, there are preferably provided a plurality of torsion springs 200 that connect the mirror housing 20 and the cover 30. FIG. 8 shows an example, wherein two torsion springs 200 are applied, which may cause the cover 30 to be opened or closed completely.

Thus, in the mirror device for a sun visor of a vehicle according to the present invention so configured, the cover 30 and the mirror housing 20 are connected by the elongation member 100 including the torsion spring 200, so that the cover 30 is a slidable semi-automatic cover, which is opened or closed by elastic force when a user opens or closes the cover 30 partially. Thus, noise is restrained from being generated, and at the same time, the cover is completely opened and closed and can be prevented from being misoperated, thereby enhancing user's convenience and improving the product quality of a vehicle.

The aforementioned embodiments are only examples for explaining the technical spirit of the present invention, and the scope of the present invention is not limited to the drawings or embodiments.

What is claimed is:

1. A mirror device for a sun visor of a vehicle, comprising:
a mirror housing;
a mirror disposed in the mirror housing; and
a cover sliding from the mirror housing to open or close the mirror,
wherein the mirror housing and the cover are coupled to each other by an elongation member that is elastically deformable.

2. The mirror device as claimed in claim 1, wherein the elongation member comprises:
a case;
a guide groove formed through the case;
a pivot arm guided in the guide groove; and
an elastic body coupling the case and a distal end of the pivot arm.

3. The mirror device as claimed in claim 2, wherein the case of the elongation member is coupled to the mirror housing and the pivot arm is coupled to the cover.

4. The mirror device as claimed in claim 3, wherein a coupling point of the case of the elongation member and the mirror housing is not positioned at the same level as a coupling point of the pivot arm and the cover.

5. The mirror device as claimed in claim 3, wherein the elastic body is a spring.

6. The mirror device as claimed in claim 2, wherein the case of the elongation member is coupled to the cover and the pivot arm is coupled to the mirror housing.

7. The mirror device as claimed in claim 6, wherein a coupling point of the case of the elongation member and the cover is not positioned at the same level as a coupling point of the pivot arm and the mirror housing.

8. The mirror device as claimed in claim 7, wherein the elastic body is a spring.

9. The mirror device as claimed in claim 1, wherein the elongation member comprises:
a case;
a guide groove formed through the case;
two separate pivot arms guided in the guide groove; and
an elastic body coupling the two separate pivot arms inside the case,
wherein the two pivot arms are respectively coupled to the mirror housing and the cover.

10. The mirror device as claimed in claim 9, wherein the case further comprises at least a catching portion formed at opening of the guide groove and the pivot arms further comprises at least a protrusion formed at an inner end of the pivot arm in the case to prevent the pivot arms from separating from the case.

11. The mirror device as claimed in claim 10, wherein each end of the elongation member is coupled to the mirror housing and the cover respectively.

12. The mirror device as claimed in claim 1 1, wherein a coupling point of the elongation member and the mirror housing is not positioned at the same level as a coupling point of the elongation member and the cover.

13. The mirror device as claimed in claim 12, wherein the elastic body is a spring.

14. A mirror device for a sun visor of a vehicle, comprising:
a mirror housing;
a mirror disposed in the mirror housing; and
a cover sliding from the mirror housing to open or close the mirror,
wherein the mirror housing and the cover are respectively coupled to both ends of a torsion spring.

15. The mirror device as claimed in claim 14, wherein a coupling point of the torsion spring and the mirror housing is not positioned at the same level as a coupling point of the torsion spring and the cover.

16. The mirror device as claimed in claim 15, wherein the torsion spring comprises a plurality of torsion springs.
